(19) United States
(12) Patent Application Publication
(10) Pub. No.: US 2003/0134555 A1
(43) Pub. Date: Jul. 17, 2003

(54) Dishwash detergent impregnated into absorbent materials

(76) Inventors: Elion Jeffrey Krok, Irvine, CA (US); Frederick N. Slosman, Asheville, NC (US); Jerry L. Gaddy, Asheville, NC (US)

Correspondence Address: Elion J. Krok, 53 Firwood, Irvine, CA, 92604, US

(21) Appl. No.: 10/047,112

(22) Filed: Jan. 17, 2002

(51) Int. Cl. B32B 3/00; B32B 5/02; B32B 9/00; B32B 27/04; B32B 27/12

(52) U.S. Cl. 442/128; 442/59; 442/123; 442/126

(57) ABSTRACT

Dishwash detergents can be impregnated into absorbent materials, especially absorbent nonwoven abrasive cloth, and such compositions are useful and effective for hand cleaning of dishes, plates, flatware and cooking equipment and the like, by reconstituting the detergent by ordinary tap water which is always readily available in the setting for which it is intended.

### 1. FIELD OF THE INVENTION

The present invention relates to scouring and cleaning products, for cleaning dishes, flatware, cooking utensils and equipment, and particularly to a non-woven fabric impregnated with a dishwashing detergent that has been cured onto the substrate having been forcibly dried such that moisture from the dishwashing detergent has been removed. In addition the non-woven fabric scouring apparatus may contain abrasive particles. The invention has particular utility in providing a convenient and germ free method of hand washing of dishes and the like, due to the dry format of the wipes.

### 2. BACKGROUND OF THE INVENTION

The present invention relates to cleaning and scouring wipes for hand washing of cooking equipment, dishes, flatware and the like.

Scouring pads have been used for decades in the kitchen. These same scouring pads are usually made of an abrasive material which has been manufactured so as to provide a pad which is capable of scrubbing the utensil being cleaned. By their very nature these pads have in their construction a multitude of channels and spaces. The pad is used typically in conjunction with a formulation which most commonly contains surfactants, foaming agent, and various combinations thereof together with an antimicrobial in some instances. Concomitant with recent consumer awareness of the need for increased hygiene particularly in the kitchen where food preparation takes place, manufacturers and consumers of sponges and scouring pads have respectively come to realize that these same cleaning items are indeed serving to store microbes because of their high water content in the first instance and more particularly because of their propensity to trap food particulates in their intricate channels and spaces.

### 3. PRIOR ART

Many have attempted to address the issue of microbes as it relates to cleaning and scouring products.

For example chelating polymers and metal complex for use in water absorbing porous article such as a sponge or scouring pad. (Roenigk in U.S. Pat. No. 5,541,233.)

In addition various types of scouring pads have been devised. The non-woven scouring pad of Winston in U.S. Pat. No. 3,103,031 has reference, which incorporates a combination of synthetic fibers and interwoven non-metallic filaments. Yet others such as Cameron in U.S. Pat. No. 3,109,191 have attempted to defeat this natural tendency to microbe formation within scouring pads by combining a non-woven synthetic fiber bound with an adhesive and the fibers then plated with metal.

Yet others have developed complex chemical approaches and their teachings are referenced in Guilbault et al., in U.S. Pat. No. 4,649,079, which describes a hydrophobic biocide which is coated onto the fiber substrate of the cleaning apparatus. Others have patented fibers similar to those described in U.S. Pat. No. 2,958,593 to Hoover et al., U.S. Pat. No. 3,280,517 to Copeland; U.S. Pat. No. 4,715,150 to Takeuchi et al., and yet others such as Ferziger et al. in U.S. Pat. No. 4,801,493; U.S. Pat. No. 5,856,002 to Moiri.

Sheridan et al. in U.S. Pat. No. 5,094,770 describes a substantially dry cleaning wipe, however the method of producing a dry wipe is essentially by combining the substrate with a non aqueous solution comprising at least one glycol compound in at least 25-75% weight and a cationic solution between 0.2 and 60% by weight. In our invention, the method of producing a dry wipe is essentially by removal of water. In U.S. Pat. No. 3,283,357 Decker et al. discloses a substantially dry wipe which is primarily intended as a disinfecting cleansing pad for use in applying a germicidal to the skin in general medicinal uses.

More recently, U.S. Pat. No. 6,299,520 to Cheyne references a nonabsorbent, abrasive scrubbing pad, especially for use in the kitchen or bathroom, comprising a nonwoven web of fibers in which the fibers have coated thereon a mixture of antimicrobial compounds.

Each of the above prior art patents discloses a method of dealing with the inhibition of microbes in the context of a cleaning apparatus which contains either and/or spaces or channels and contain a relatively significant moisture content. This requires the inhibition of microbe formation rather than addressing and altering the environment of the cleaning or scouring pads. It is well versed that prevention is better than cure. Accordingly, it clearly appears there continues to be a need for a cleaning or scouring pad, that has an altered environment which in itself tends towards the prevention of microbes. This is accomplished by eliminating food trapping channels and spaces, and more significantly be providing a dishwashing detergent such that the water content thereof has been forcibly removed so as to leave the active ingredients suitably cured and coated onto the fibers of the cleaning or scouring pad and that does not otherwise possess the disadvantages of the prior art devices.

In addition, the present invention refers to a cleaning and scouring wipe which is intended for single use application, this further assisting with the elimination of the microbe load in and around the kitchen.

### 4. FEDERALLY SPONSORED RESEARCH AND DEVELOPMENT

No federally sponsored research and development has been used in this invention

### 5. SUMMARY OF THE INVENTION

This invention is a novel cleaning or scouring pad for use in cleaning dishes, plates, flatware and cooking equipment. In one embodiment the said cleaning pad is a dry wipe, comprising a nonwoven material, the fibers of which have been coated with a suitable dishwashing detergent, and the moisture content forcibly removed. The nonwoven fabric is preferably but not necessarily abrasive.

The main objective of the invention is to provide a scouring pad which is in and of itself completely dry, whilst comprising the active chemicals of a dishwash detergent. This has the practical objective of providing a scouring pad which has a significantly reduced incidence of microbe development. The invention has the added objectives of providing an effective product which is convenient, and economical. It is furthermore an added objective of the invention, that the scouring pads will be light and thereby easily transportable. The scouring pads will also have the added advantage of having an extended shelf life.

These and other objects of the invention will become more clear when one reads the following specification, taken together with the drawings that are attached hereto. The scope of protection sought by the inventors may be gleaned from a fair reading of the claims that conclude this specification.

### 6. DESCRIPTION OF THE DRAWINGS

No Drawings

### 7. DESCRIPTION OF THE INVENTION

The present invention relates to a cleaning or scouring pad which is comprised of a substrate being a nonwoven fabric, the fibers of which are coated with the chemically active ingredients of a liquid detergent, the moisture of which has been forcibly removed so as to provide an essentially dry cleaning pad.

The Substrate:—In the preferred embodiment just described, the use of an absorbent substrate is essential to the invention. The substrate of the dry wipes being a nonwoven “absorbent” are fully disclosed in the technical documents of Ahlstrom, and more particularly known as Hydroscrub™, incorporated herein by reference. It is also recorded that many other substrates are suitable for use in this application, and these substrates may or may not contain abrasives. It is known that most substances are able to absorb a liquid substance to some degree; however, the term “absorbent” as used herein, is intended to mean a substance with an absorbent capacity (i.e., a parameter representing a substrate's ability to take up and retain a liquid) from 4 to 12, preferably 5 to 7, times its weight of water.

The Active Ingredients

The preferred dishwashing detergent formulation is reduced by heating the temperature to about 65-95° C., to create a molten thickened paste of dishwashing detergent. The percentage of thickening agent such as Sodium Chloride may be increased 5-10% to further aid in the thickening. The mixture is then processed by mixing and maintained at the optimal temperature and applied to a trough.

### EXAMPLES OF PREPARING DRY DISHWASH SUBSTRATE ARTICLES

The above reaction mixtures are used in preparing substrate articles, in molten form and processed at from about 60.degree.−90.degree. C. to reduce the particle size of the complex agglomerates to less than about 200 microns.

Preparation of Dry Dishwash Sheets

The premix in molten form are pumped to an impregnation head which distributes the molten dishwash composition as a final coating mix across the width of a substrate.

The flexible substrate, is impregnated by coating one or both sides of a continuous length of the substrate and contacting it with a rotating cylindrical member which serves to press the liquefied mixture into the interstices of the substrate. The amount of molten dishwash detergent paste applied is controlled by the flow rate of the mixture and/or the line speed of the substrate and/or the pressure of the rotating cylindrical roller. The substrate is passed over several tension rollers which help solidify the dishwash mixture. The excess moisture drips off, after which the substrate with the coated dishwash paste is cured by

Having particularly described the invention in detail what we now claim is:

1. A substantially anhydrous dishwash sheet consisting essentially of a dishwash detergent impregnated into an absorbent substrate having an absorbent capacity of from 5 to 12 and having said dishwash detergent suitably dehydrated by forcible removal of all apparent moisture.

2. The dry sheets of claim 1 being suitably dehydrated constitute a significant alteration in environment for the replication of microbes in and around the sink and other areas where dishes, plates, flatware, cooking equipment and the like are cleaned.

3. The dry sheets of claim I are suitable for single use applications and the sheets are intended to be discarded after use, due regard being considered for recycle regulations.

4. The dry sheets of claim 1 are more convenient than hitherto described or used cleaning or scouring pads.

5. The composition of claim 1 where the cloth being of nonwoven fabric having a basis weight of from 40-45 grams per square yard.

6. The composition of claim 1 wherein the ratio of dishwash detergent solids to nonwoven absorbent substrate is from 1:2 by weight of the dry substrate.

7. The dry sheets of claim 1 are readily used as a convenient means of cleaning dishes, plates, flatware and the like. Upon contact with water from an ordinary source such as a tap, the dishwashing detergent is suitably reconstituted.

8. The substrate of claim 5. has an abrasive texture suitably adhered to one or both of the surfaces.

9. The dry dishwash sheets of claim 1 are suitable for camping and traveling especially as the invention described in claim 1. is of a light weight, and furthermore does not have any tendency to leak, as it is a dry product.

10. The dry dishwash sheets of claim 1 are suitable for increased shelf life and not subject to microbe formation over an extended period of time, by virtue of the removal of all water content.
